(19) United States
(12) Patent Application Publication
(10) Pub. No.: US 2026/0220989 A1
(43) Pub. Date: Jul. 30, 2026

(54) DYNAMIC POWER MANAGEMENT FOR AUTOMOTIVE EMBEDDED SYSTEMS

(71) Applicant: QUALCOMM Incorporated, San Diego, CA (US)

(72) Inventors: Madhu Yashwanth Boenapalli, Hyderabad (IN); Sai Praneeth Sreeram, Anantapur (IN); Manmeet Singh Ahluwalia, Bangalore (IN); Vinod Kumar Enapakurthi, Hyderabad (IN); Surendra Paravada, Hyderabad (IN)

(21) Appl. No.: 19/041,708

(22) Filed: Jan. 30, 2025

(51) Int. Cl. G07C 5/10; B60R 16/023; G06F 11/30; G07C 5/08

(52) U.S. Cl. CPC G07C 5/10; B60R 16/0231; G06F 11/3013; G06F 11/3062; G07C 5/085

(57) ABSTRACT

This disclosure provides systems, methods, and devices for dynamic power management of automotive embedded systems in vehicles. In a first aspect, a method includes determining, by a processor, a vehicle ignition frequency of an automotive embedded system of a vehicle; determining, by the processor, an occupancy rate of a dynamic memory of the automotive embedded system; determining, by the processor, based on the vehicle ignition frequency and the occupancy rate, a power management mode for the automotive embedded system; and configuring, by the processor, the automotive embedded system based on the power management mode. Other aspects and features are also claimed and described.

### TECHNICAL FIELD

Aspects of the present disclosure relate generally to integrated circuits, and more particularly, to integrated circuits for improving system on chips (SoCs). Some features may enable and provide improved power management for automotive embedded systems.

### Introduction

Vehicles take many shapes and sizes, are propelled by a variety of propulsion techniques, and carry cargo including humans, animals, or objects. Vehicles typically rely on automotive embedded systems for various vehicular processes, such as but not limited to braking, navigation, safety, and entertainment. As automotive embedded systems consume power, which impacts the energy efficiency of a vehicle, there is a desire and need for managing power consumption of the automotive embedded system.

Conventional approaches to managing the power consumption of the automotive embedded system involve implementing a singular power management mode. While some power management modes have better key performance indicators (KPI) for booting the system and reduced battery consumption but exhibit inherent limitations when quicker access to system images existing prior to the booting. Other power management modes that optimize for better image retention when booting have less favorable boot KPIs and conserve battery power less favorably.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In some aspects, systems and methods are described for a dynamic power management of automotive embedded systems in vehicles. Various embodiments describe configuring the automotive embedded system to a power management configuration based on vehicle usage characteristics, such as the vehicle ignition frequency and/or the occupancy rate of the dynamic memory of the automotive embedded system. The vehicle ignition frequency may relate to how frequently the vehicle is started. The occupancy rate of the dynamic memory may relate to how occupied the automotive embedded system may be (e.g., based on ongoing applications and processes). The power management configuration may be one of at least two power management configurations based on the aforementioned vehicle usage characteristics. A power management configuration of suspend to disk (S2D) may be implemented when the vehicle ignition frequency is determined to be high and the occupancy rate of the dynamic memory is determined to be high. Furthermore, a power management configuration of deep sleep-quick boot (DS-QB) may be implemented when the vehicle ignition frequency is determined to be high but the occupancy rate of the dynamic memory is determined to be low. S2D may also be implemented when the vehicle ignition frequency is determined to be low.

The different power management configurations based on the different vehicle usage needs help to ensure that power management configurations favoring image retention are implemented when there is higher demand to quickly return to ongoing processes and applications, whereas power management configurations favoring reduced battery consumptions and booting KPIs are implemented when there is either a reduced need for the vehicle (e.g., based on vehicle ignition frequency) or when there may be a less activity over all (e.g., as measured by the occupancy rate).

In one aspect of the disclosure, a method for a dynamic power management of an automotive embedded system in a vehicle includes: determining, by a processor, a vehicle ignition frequency of an automotive embedded system of a vehicle; determining, by the processor, an occupancy rate of a dynamic memory of the automotive embedded system; determining, by the processor, based on the vehicle ignition frequency and the occupancy rate, a power management mode for the automotive embedded system; and configuring, by the processor, the automotive embedded system based on the power management mode.

In some embodiments, determining the vehicle ignition frequency includes determining that the vehicle ignition frequency is above a first threshold, determining the occupancy rate of the dynamic memory includes determining that the occupancy rate is above a second threshold, and determining the power management mode for the automotive embedded system includes determining to implement a suspend to disk (S2D) power management mode based on the vehicle ignition frequency and the occupancy rate.

In some embodiments, determining the vehicle ignition frequency includes determining that the vehicle ignition frequency is above a first threshold, determining the occupancy rate of the dynamic memory includes determining that the occupancy rate is below a second threshold, and determining the power management mode for the automotive embedded system includes determining to implement a deep sleep-quick boot (DS-QB) power management mode based on the vehicle ignition frequency and the occupancy rate.

In some embodiments, determining the vehicle ignition frequency includes determining that the vehicle ignition frequency is below a first threshold, and wherein determining the power management mode for the automotive embedded system includes determining to implement a suspend to disk (S2D) power management mode based on the vehicle ignition frequency.

In some embodiments, determining the vehicle ignition frequency includes: determining, by the processor, a frequency of a signal received by a low power mode controller area network (LPM-CAN) of the automotive embedded system indicating an ignition of the vehicle.

In some embodiments, determining the occupancy rate of the dynamic memory includes: determining a ratio of cells of the dynamic memory storing data used in active processes to a total number of cells in the dynamic memory, wherein the occupancy rate is based on the ratio.

In some embodiments, the power management mode is a deep sleep-quick boot (DS-QB) power management mode. Furthermore, configuring the automotive embedded system includes: determining, by the processor, application processes and system processes utilizing the dynamic memory; retaining, by the processor, contexts for the application processes; and reloading, by the processor, the system processes during a start up of the automotive embedded system.

In some embodiments, the power management mode is a suspend to disk (S2D) power management mode. Furthermore, configuring the automotive embedded system includes: determining, by the processor, application processes and system processes utilizing the dynamic memory; and retaining, by the processor, contexts for the application processes and the system processes.

In some embodiments, the power management mode is determined via a machine learning model. For example, the machine learning model can be trained to output a power management mode based on inputs comprising a vehicle ignition frequency and an occupancy rate.

In an additional aspect of the disclosure, an apparatus includes at least one processor and a memory coupled to the at least one processor. The at least one processor is configured to perform operations including determining a vehicle ignition frequency of an automotive embedded system of a vehicle; determining an occupancy rate of a dynamic memory of the automotive embedded system; determining, based on the vehicle ignition frequency and the occupancy rate, a power management mode for the automotive embedded system; and configuring the automotive embedded system based on the power management mode. In some embodiments, the at least one processor may be further configured to perform any of the aforementioned methods.

In an additional aspect of the disclosure, an automotive embedded system is disclosed, which includes: a low power mode controller area network (LPM-CAN) configured to receive a signal indicating an ignition of a vehicle; a memory; and at least one processor coupled to the memory and the LPM-CAN. The at least one processor is configured to execute processor-readable code to cause the at least one processor to perform operations including: determining, based on input from the LPM-CAN, a vehicle ignition frequency of an automotive embedded system of a vehicle; determining an occupancy rate of the memory; and determining, based on the vehicle ignition frequency and the occupancy rate, a power management mode for the automotive embedded system comprising one of a suspend to disk (S2D) operation or a deep sleep-quick boot (DS-QB) operation; and configuring the automotive embedded system based on the power management mode.

In some embodiments, the at least one processor is further configured to: determine the vehicle ignition frequency by determining whether the vehicle ignition frequency satisfies a first threshold. The at least one processor is configured to determine the occupancy rate of the memory by determining whether the occupancy rate satisfies a second threshold. The at least one processor is configured to determine the power management mode for the automotive embedded system by determining to execute a suspend to disk (S2D) operation when: the vehicle ignition frequency satisfies the first threshold and the occupancy rate satisfies the second threshold, or the vehicle ignition frequency is not above the first threshold. Furthermore, the at least one processor is configured to determine the power management mode for the automotive embedded system by determining to execute a deep sleep-quick boot (DS-QB) operation when the vehicle ignition frequency satisfies the first threshold and the occupancy rate fails to satisfy the second threshold.

In an additional aspect of the disclosure, a non-transitory computer-readable medium stores instructions that, when executed by at least one processor, cause the processor to perform operations. The operations include determining, by a processor, a vehicle ignition frequency of an automotive embedded system of a vehicle; determining, by the processor, an occupancy rate of a dynamic memory of the automotive embedded system; determining, by the processor, based on the vehicle ignition frequency and the occupancy rate, a power management mode for the automotive embedded system; and configuring, by the processor, the automotive embedded system based on the power management mode. In some embodiments, the operations may further include any of the aforementioned methods.

The integrated circuits and System on Chips (SoCs) described herein may be used for processing of various kinds of data, including audio signal processing, video processing, artificial intelligence (AI) processing, mathematical computations, database processing, image processing, and other kinds of data processing. These integrated circuits and/or SoCs can be incorporated into a wide variety of devices, such as vehicles and automotive embedded systems in vehicles. By way of example, they may be incorporated into audio devices, such as entertainment devices in vehicles, wireless communication devices in vehicles, gaming devices in vehicles, computing devices of vehicles such as webcams, video surveillance cameras, or other devices that process data using processing circuitry (e.g., application specific integrated circuits (ASICs), digital signal processors (DSP), graphics processing unit (GPU), or central processing units (CPU)).

In some aspects, a device may include a digital signal processor or a processor (e.g., an application processor) including specific functionality for data processing. Operations on different kinds of data may be performed by different processors, or various operations may be split between the various data processing circuitry (e.g., ASICs, DSP, GPU, CPU, NPU). In some embodiments, the methods and techniques disclosed herein may be adapted for use in a neural signal processor (NSP) in which one or more parameters of data processing are controlled based on output from a machine learning (ML) model executed by the NSP.

Other aspects, features, and implementations will become apparent to those of ordinary skill in the art, upon reviewing the following description of specific, exemplary aspects in conjunction with the accompanying figures. While features may be discussed relative to certain aspects and figures below, various aspects may include one or more of the advantageous features discussed herein. In other words, while one or more aspects may be discussed as having certain advantageous features, one or more of such features may also be used in accordance with the various aspects. In similar fashion, while exemplary aspects may be discussed below as device, system, or method aspects, the exemplary aspects may be implemented in various devices, systems, and methods.

The method may be embedded in a computer-readable medium as computer program code comprising instructions that cause a processor to perform the steps of the method. In some embodiments, the processor may be part of an automotive embedded system including a first network adaptor configured to transmit data over a first network connection of a plurality of network connections; and a processor coupled to the first network adaptor and the memory. The processor may cause the transmission of output signals described herein over a wired or wireless communications network such as a 5G NR communication network, for example, to effect, configure, and/or implement a power configuration mode for the automotive embedded system.

The foregoing has outlined, rather broadly, the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

FIG. 1 shows a block diagram of a system-on-chip (SoC) that is an automotive embedded system according to one or more aspects of this disclosure.

FIG. 2 is a block diagram illustrating an example automotive embedded system situated in a vehicle and configured for dynamic power management according to one or more aspects of the disclosure.

FIG. 3 shows a flow chart of an example method for dynamic power management of an automotive embedded system according to one or more aspects of this disclosure.

FIG. 4 shows a process flow diagram of an example method for dynamic power management of an automotive embedded system according to one or more aspects of this disclosure.

FIG. 5 is a schematic diagram illustrating aspects of the automotive embedded system used in an example implementation of dynamic power management for the automotive embedded system according to one or more aspects of the disclosure.

Like reference numbers and designations in the various drawings indicate like elements.

### DETAILED DESCRIPTION

The present disclosure provides systems, apparatus, methods, and computer-readable media that support improved integrated circuit operation, including techniques for dynamic power management of an automotive embedded system.

Conventional approaches to managing power consumption of automotive embedded systems in vehicles involve implementing a singular power management mode. The use of a singular power management mode presents tradeoffs which are not optimized for the needs of the automotive embedded system. For example, power management modes such as suspend-to-ram (S2R) and suspend-to-disk (S2D) may achieve relatively comprehensive state preservation of the system during a boot-up process, such as by preserving system images for high level operation systems (HLOS), non-HLOS, and processor contexts (e.g., Q6). However, the extensive image retention causes S2R and S2D to have relatively poorer key performance indicators (KPIs) for booting the automotive embedded system (referred to herein as “boot KPIs”). In various embodiments, boot KPIs may include but are not limited to, a latency between vehicle ignition and the start or restoration of a process on the automotive embedded system, a latency between the vehicle ignition and an application launch or application restoration on the automotive embedded system, a latency between the vehicle ignition and the appearance of a graphical user interface on a dashboard of the vehicle, etc. Furthermore, the extensive image retention in S2R and S2D leads to higher battery consumption during the boot up process.

In contrast, power management modes such as deep sleep quick boot (DS-QB) may have better boot KPIs due to a more limited system image retention during a boot up process, which can ultimately lead to a longer battery life for the vehicle, especially when DS-QB is regularly used for power management. However, in management modes such as DS-QB, only a limited set of system images are retained, such as but not limited to extensible boot loaders (XBL, XBL_Sec, etc.), hypervisor execution environments (e.g., QTEE, HYP, etc.) and high level operating systems (HLOS).

A power management configuration that singularly defaults to one of the aforementioned modes thus compromises automotive embedded systems, whether it is losing retention of contexts for applications processes, impacting the latency associated with a boot up process, or by reducing battery life. Shortcomings mentioned here are only representative and are included to highlight problems that the inventors have identified with respect to existing devices and sought to improve upon. Aspects of devices described below may address some or all of the shortcomings as well as others known in the art. Aspects of the improved devices described herein may present other benefits than, and be used in other applications than, those described above.

Particular implementations of the subject matter described in this disclosure may be implemented to realize one or more of the following potential advantages or benefits. In some aspects, the present disclosure provides techniques for dynamically managing the power of automotive embedded systems in vehicles. In various embodiments, the automotive embedded system is set to a power management configuration based on vehicle usage characteristics, such as the vehicle ignition frequency and the occupancy rate of the dynamic memory of the automotive embedded system. The vehicle ignition frequency may relate to how frequently the vehicle is started. The occupancy rate of the dynamic memory may represent a current workload of the embedded system. The power management configuration may be one of at least two power management configurations based on the aforementioned vehicle usage characteristics. A power management configuration of suspend to disk (S2D) may be implemented when the vehicle ignition frequency is determined to be high (e.g., above a first threshold) and the occupancy rate of the dynamic memory is determined to be high (e.g., above a second threshold). Furthermore, a power management configuration of deep sleep-quick boot (DS-QB) may be implemented when the vehicle ignition frequency is determined to be high (e.g., above the first threshold or above a third threshold) but the occupancy rate of the dynamic memory is determined to be low (e.g., below the second threshold or below a fourth threshold). S2D may also be implemented when the vehicle ignition frequency is determined to be low (e.g., below the first threshold, below the third threshold, or below a fifth threshold).

The different power management configurations based on the different vehicle usage needs help to ensure that power management configurations favoring image retention are implemented when there is higher demand to quickly return to ongoing processes and applications, whereas power management configurations favoring reduced battery consumptions and booting KPIs are implemented when there is either a reduced need for the vehicle (e.g., based on vehicle ignition frequency) or when there may be a less activity over all (e.g., as measured by the occupancy rate).

The detailed description set forth below, in connection with the appended drawings to which the text references, is intended as a description of various embodiments and is not intended to limit the scope of the disclosure. Rather, the detailed description includes specific details for the purpose of providing a thorough understanding of the subject matter of this disclosure. It will be apparent to those skilled in the art that these specific details are not required in every case and that, in some instances, well-known structures and components are shown in block diagram form for clarity of presentation.

In the description of embodiments herein, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well known circuits and devices are shown in block diagram form to avoid obscuring teachings of the present disclosure.

Some portions of the detailed descriptions which follow are presented in terms of procedures, logic blocks, processing, and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

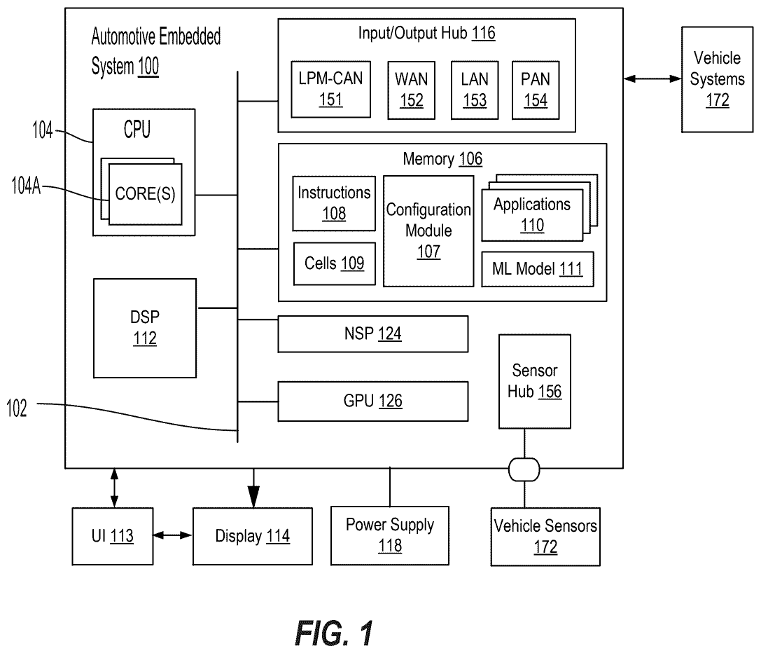

FIG. 1 shows a block diagram of a system-on-chip (SoC) that is an automotive embedded system according to one or more aspects of this disclosure. The SoC 100 (also referred to herein as the automotive embedded system) may include several components coupled together through a bus 102, which may be a network-on-a-chip (NoC) or a plurality of NoCs interconnecting various components. For example, although FIG. 1 illustrates several components coupled to the bus 102, the several components may be coupled to different busses with additional busses connecting the different busses to provide a path for communication between the components.

One example component in the automotive embedded system 100 is a digital signal processor 112 for signal processing. The DSP 112 may process various image, video, and/or audio signals for applications that can be used by the automotive embedded system 100 (e.g., maps, navigation, radio, entertainment, etc.). The DSP 112 may include hardware customized for performing a limited set of operations on specific kinds of data. For example, a DSP may include transistors coupled together to perform operations on streaming data and use memory architectures and/or access techniques to fetch multiple data or instructions concurrently. Such configurations may allow the DSP 112 to operate on real-time data, such as video data, audio data, or modem data, in a power-efficient manner.

The automotive embedded system 100 also includes a central processing unit (CPU) 104 and a memory 106 storing instructions 108 (e.g., a memory storing processor-readable code or a non-transitory computer-readable medium storing instructions) that may be executed by a processor of the automotive embedded system 100. The CPU 104 may be a single central processing unit (CPU) or a CPU cluster comprising two or more cores such as core 104A. The CPU 104 may include hardware capable of performing generic operations on many kinds of data, such as hardware capable of executing instructions from the Advanced RISC Machines (ARM®) instruction set, such as ARMv8 and ARMv9. For example, a CPU 104 may include transistors coupled together to perform operations for supporting executing an operating system and user applications (e.g., a camera application, a multimedia application, a gaming application, a productivity application, a messaging application, a videocall application, an audio recording application, a video recording application, a navigation application, an autonomous driving application, etc.). The CPU 104 may execute instructions 108 retrieved from the memory 106. In some embodiments, the CPU 104 executing an operating system may coordinate execution of instructions by various components within the automotive embedded system 100. For example, the CPU 104 may retrieve instructions 108 from memory 106 and execute the instructions on the DSP 112.

The automotive embedded system 100 may further include a neural signal processor (NSP) 124 for executing machine learning (ML) models relating to multimedia applications. The NSP 124 may include hardware configured to perform and accelerate convolution operations involved in executing machine learning algorithms. For example, the NSP 124 may improve performance when executing predictive models such as artificial neural networks (ANNs) (including multilayer feedforward neural networks (MLFFNN), the recurrent neural networks (RNN), and/or the radial basis functions (RBF)). The ANN executed by the NSP 124 may access predefined training weights stored in the memory 106 for performing operations on user data.

The automotive embedded system 100 may be coupled to a display 114 (e.g., a dashboard) for interacting with a user. The automotive embedded system 100 may also include a graphics processing unit (GPU) 126 for rendering images on the display 114. In some embodiments, the CPU 104 may perform rendering to the display 114 without a GPU 126. In some embodiments, the GPU 126 may be configured to execute instructions for performing operations unrelated to rendering images, such as for processing large volumes of datasets in parallel.

The automotive embedded system 100 may include an integrated circuit, such as included in one of the processors (e.g., DSP 112, CPU 104, NSP 124, GPU 126) to provide applications and/or operations in the automotive embedded system, determine vehicle usage characteristics based on the applications and/or operations and based on vehicle ignition frequency, and dynamically manage the power consumption of the automotive embedded system. Examples of applications in the automotive embedded system may include propulsion systems, braking systems, steering systems, autopilot systems, image processing systems, data recording systems, and/or other applications that control and/or monitor aspects of the vehicle.

Processing algorithms, techniques, and methods may be executed by at least one processor of the automotive embedded system 100, which may include execution by all steps on one of the processors (e.g., DSP 112, CPU 104, NSP 124, GPU 126) or may include execution of steps across a combination of one or more of the processors (e.g., DSP 112, CPU 104, NSP 124, GPU 126). In some embodiments, at least one of the DSP 112 or the CPU 104 executes instructions to perform various operations described herein, including dynamic power management of the automotive embedded system. For example, execution of the instructions by the CPU 104 as part of a multimedia application (e.g., a voice recorder, a sound recording, or a video recorder) may instruct the DSP 112 to begin or end capturing audio (e.g., a voice command for navigation of the vehicle). The operations of the CPU 104 may be based on user input. For example, a voice recorder application executing on a processor (e.g., CPU 104) may receive a user command based on a voice (e.g., a voice command) g upon which audio comprising one or more channels is captured and processed. The audio may be processed by the DSP 112 to effect an electronic signal relevant for the automotive embedded system, such as entering a destination for vehicle navigation. Applications based on the audio processing, such as the vehicle navigation application, may occupy the dynamic memory of the automotive embedded system 100, such as memory 106. A processor, such as the CPU 104, via instructions 108, may determine a power management mode for the automotive embedded system 100 based on the occupancy level of the dynamic memory, which is affected by the vehicle navigation application. In some embodiments, the power management mode may be further based on other vehicle usage characteristics, such as the vehicle ignition frequency obtained via the I/O hub 116, as will be described herein.

Input/output components may be coupled to the automotive embedded system 100 through an input/output (I/O) hub 116. An example of a hub 116 is an interconnect to a peripheral component interconnect express (PCIe) bus. Example components coupled to hub 116 may be components used for interacting with a user and/or the vehicle, such as a touch screen interface and/or physical buttons to interact with the user, and a low power mode controller area network (LPM-CAN) 151 to interact with vehicle systems 172 of the vehicle. As will be described herein, such vehicle systems 172 may operate mechanical aspects of the vehicle such as activating or deactivating the vehicle (vehicle ignition). In some embodiments, the LPM-CAN 151 may be a form of controller area network (CAN), a robust communication protocol for automotive systems, which allows seamless interaction among various electronic control units (ECUs) within the vehicle. The LPM-CAN 151 may be a form of CAN that can be implemented in a low-power state during vehicle inactivity. In some embodiments, the LPM-CAN 151 may periodically monitor for signals received through the CAN, such as but not limited to those related to ignition, engine status, and user interactions. In some embodiments, the LPM-CAN 151 may be used to determine a vehicle ignition frequency by analyzing the frequency of signals related to the ignition (e.g., activation) of the vehicle and/or identifying patterns indicative of vehicle activity.

Some components coupled to hub 116 may also include network interfaces for communicating with other devices, including a wide area network (WAN) adaptor (e.g., WAN adaptor 152), a local area network (LAN) adaptor (e.g., LAN adaptor 153), and/or a personal area network (PAN) adaptor (e.g., PAN adaptor 154). A WAN adaptor 152 may be a 4G LTE or a 5G NR wireless network adaptor. A LAN adaptor 153 may be an IEEE 802.11 WiFi wireless network adapter. A PAN adaptor 154 may be a Bluetooth wireless network adaptor. Each of the WAN adaptor 152, LAN adaptor 153, and/or PAN adaptor 154 may be coupled to an antenna that may be shared by each of the adaptors 152, 153, and 154, or coupled to multiple antennas configured for primary and diversity reception and/or configured for receiving specific frequency bands. In some embodiments, the WAN adaptor 152, LAN adaptor 153, and/or PAN adaptor 154 may share circuitry, such as portions of a radio frequency front end (RFFE).

A sensor hub 156 may be integrated in the automotive embedded system 100 as dedicated circuitry for receiving, processing, and/or otherwise coupling the automotive embedded system 100 to one or more vehicle sensors 172, which may be external to the automotive embedded system 100 but in the vehicle. The sensor hub 156 may be or may include a telematics system configured to translate physical signals into digital and/or electronic signals that may be received and/or further processed by a combination of the sensor hub 156 and/or other processors of the automotive embedded system (e.g., CPU 104, DSP 112, GPU 126, and/or NSP 124).

The automotive embedded system 100 may couple to external devices outside the package of the automotive embedded system 100. For example, the automotive embedded system 100 may be coupled to a user interface (UI) for enabling a user to input commands to the automotive embedded system, such as for interacting with one or more applications 110 running on the automotive embedded system. For example, the automotive embedded system 100 may be coupled to a power supply 118, such as a battery or an adaptor to couple the automotive embedded system 100 to an energy source. The dynamic power management of the automotive embedded system described herein may be adapted to and achieve power efficiency to support operation of the automotive embedded system 100 from a limited-capacity power supply 118 such as a battery. For example, the automotive embedded system 100 configured to perform shut-down, start-up, and/or other power management processes in a manner that optimizes for low power consumption in certain circumstances, while optimizing for better system image retention in other circumstances. As another example, operations themselves are performed in a manner that reduces an amount of computations to perform the operation, such that the algorithm is optimized for extending the operational time of a device while powered by a limited-capacity power supply 118. In some embodiments, the operations described herein may be configured based on a type of power supply 118 providing energy to the automotive embedded system 100. For example, a first set of operations may be executed to perform a function when the power supply 118 is a wall adaptor (e.g., for an electric vehicle). As another example, a second set of operations may be executed to perform a function when the power supply 118 is a battery.

The automotive embedded system 100 may also include or be coupled to additional features or components that are not shown in FIG. 1. Although components are shown integrated as a single automotive embedded system 100, which may include all components built on a single semiconductor die with a common semiconductor substrate, other arrangements of the illustrated blocks different number of dies, substrates, and/or packages may be arranged to accomplish the same functionality described in this disclosure.

The memory 106 may include a non-transient or non-transitory computer readable medium storing computer-executable instructions as instructions 108 to perform all or a portion of one or more operations described in this disclosure. The instructions 108 may include a multimedia application (or other suitable application such as a messaging application) to be executed by the automotive embedded system 100 that records, processes, or outputs audio signals. The instructions 108 may also include other applications or programs executed by the automotive embedded system 100, such as an operating system and applications other than for multimedia processing.

In addition to instructions 108, the memory 106 may also store applications data 110, for ongoing application processes occurring on a dynamic memory (e.g., a double data rate (DDR) memory). The memory 106 may be arranged as a plurality of cells 109, of which ongoing application processes for stored applications 110 may leverage one or more cells for writing or reading application data. Such cells may be referred to herein as active cells to distinguish from other cells of the memory that may be idle or otherwise inactive due to not being engaged with any application process. In some embodiments, the automotive embedded system 100 may be coupled to an external memory and configured to access the memory for writing output application files for later execution or long-term storage. For example, the automotive embedded system 100 may be coupled to a flash storage device comprising NAND memory for storing video files (e.g., MP4-container formatted files) including audio tracks and/or storing audio recordings (e.g., MPEG-1 Layer 3 files, also referred to as MP3 files). Portions of the application files 110 may be transferred to memory 106 for processing by the automotive embedded system 100, with the resulting signals after processing encoded as applications in the memory 106 for transfer to the long-term storage. In some embodiments, the memory 106 may further include a configuration module 107, which may include a program or an instruction for determining and implementing a power configuration mode suitable for the automotive embedded system based on vehicle usage characteristics of the vehicle, as will be described herein. In some embodiments, the configuration module 107 may leverage one or more machine learning models 111 stored in the memory 106 to determine the appropriate power configuration mode for the automotive embedded system. The machine learning model 111 may be trained based on historical vehicle usage patterns of the automotive embedded system, such as historical vehicle ignition frequences and historical memory occupancy rates indicating how much of the dynamic memory was historically used for the running of applications 110.

While the automotive embedded system 100 is referred to in the examples herein for performing aspects of the present disclosure, some device components may not be shown in FIG. 1 to prevent obscuring aspects of the present disclosure. Additionally, other components, numbers of components, or combinations of components may be included in a suitable device for performing aspects of the present disclosure. As such, the present disclosure is not limited to a specific device or configuration of components, including the automotive embedded system 100.

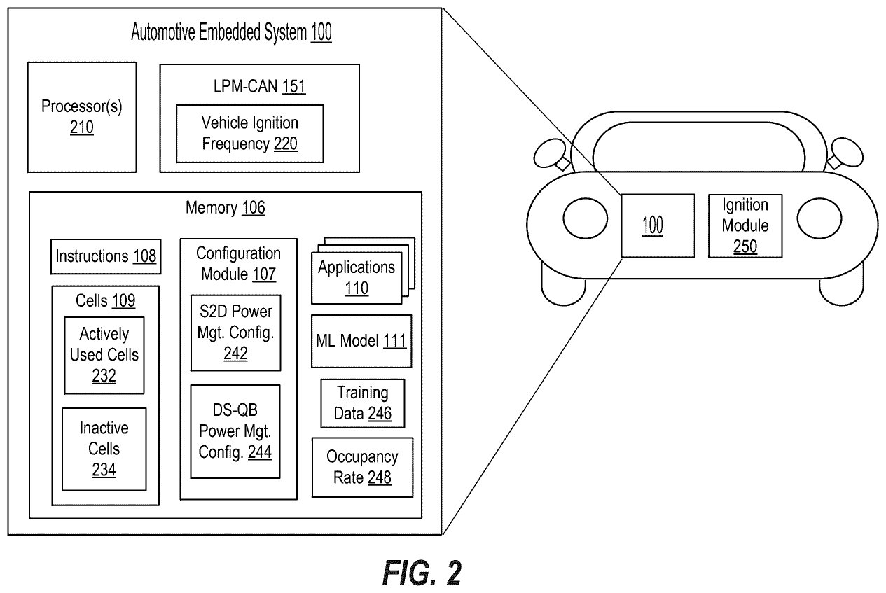

The SoC of FIG. 1 may be operated to obtain improved system restoration (e.g., image retention) during vehicle usage, reduced latency in start-up and booting processes, and improved power consumption of the automotive embedded system by dynamically managing the power configuration of the automotive embedded system based on vehicle usage characteristics of the automotive embedded system. One example integration of aspects of this disclosure into a wireless device are shown in FIG. 2 and described below.

FIG. 2 is a block diagram illustrating an example automotive embedded system in a vehicle and configured for dynamic power management according to one or more aspects of the disclosure. As shown in FIG. 2, the automotive embedded system 100 may include at least one processor 210, an LPM-CAN 151, and a memory 106 The at least one processor 210 may include any one or more processors or processing units described herein (e.g., CPU 104, DSP 112, GPU 126, NSP 124) for performing one or more techniques described herein for dynamic power management of the automotive embedded system. The at least one processor 210 may perform the techniques by executing machine readable instructions 108 stored in the memory 106.

As previously discussed, the LPM-CAN 151 may be a type of controller area network allowing the automotive embedded system 100 to interact with other vehicle systems of the vehicle. For example, the LPM-CAN 151 may allow the automotive embedded system to interact with an ignition module 250 of the vehicle, and receive information on a vehicle ignition frequency 220 based on the interaction. The ignition module 250 may be a hardware and/or software component of the vehicle detecting when the vehicle is activated and/or deactivated (e.g., vehicle ignition). The vehicle ignition frequency 220 may indicate the frequency of this ignition (e.g., how often the vehicle is started). In some embodiments, the LPM-CAN 151 may enable the interaction with vehicle systems, such as the ignition module 250, to occur in low power or in a power-efficient manner.

The memory 106 may be or may include a dynamic memory (e.g., DDR memory) arranged as a plurality of cells 109. A portion of cells 109 may be actively used cells 232 as they may be actively used by ongoing applications 110 for reading or writing data. Another portion of these cells may not be used by any applications 110 at a given time, and may be referred to as idle cells 234. It is contemplated that the proportion of the cells 109 that are actively used cells 232 may indicate the level to which the automotive embedded system is being actively used (e.g., by one or more applications 110). The level may be referred to herein as a memory occupancy rate or occupancy rate 248 may be used to determine a power management configuration for the automotive embedded system 100 as will be described herein. In some aspects, the occupancy rate 248 may be monitored (e.g., periodically) and may be stored in the memory 106. The memory 106 may further include the configuration module 107. The configuration module 107 may include software and/or hardware components for determining and implementing a power management configuration for the automotive embedded system 100. For example, the configuration module 107 may be configured to implement an S2D power management configuration 242 and a DS-QB power management configuration 1244, and instructions for both configurations may be stored in the memory 106.

In some embodiments, the memory 106 may further store or may leverage one or more machine learning models 111. The one or more machine learning models 111 may be used (e.g., by the configuration module 107) to determine the appropriate power management configuration for the automotive embedded system. The machine learning model 111 may be trained using training data 246 that may be received or periodically updated. In some embodiments, the training data 246 may include historical vehicle ignition frequences and historical memory occupancy rates for each of a plurality of historical events or time. In some embodiments, the training data may associate, for each historical event or time, an appropriate or an actual power management configuration for the automotive embedded system for supervised learning.

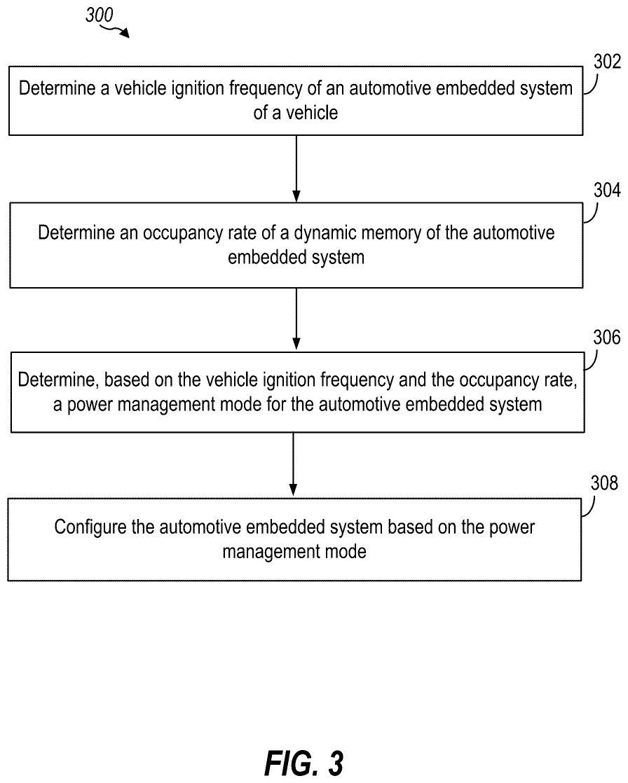

The device of FIG. 2 may be configured to perform operations described with reference to FIG. 3 to for dynamic power management of the automotive embedded system. FIG. 3 shows a flow chart of an example method for dynamic power management of an automotive embedded system according to one or more aspects of this disclosure. The operations of FIG. 3 may result in a determination and/or an implementation of a power management configuration for the automotive embedded system, which results in an improved user experience (e.g., based on reduced latency during vehicle start-up), improved power consumption and/or battery life, and improved retention of application processes and system images. Each of the operations described with reference to FIG. 3 may be performed by one or a combination of the processors of the automotive embedded system 100.

At block 302, at least one processor (e.g., processor 210, CPU 104) may determine a vehicle ignition frequency of an automotive embedded system (e.g., vehicle ignition frequency 220 of automotive embedded system 100). For example, the processor may determine whether the ignition vehicle frequency is above a predetermined threshold (referred to herein as a first threshold). As used herein, the vehicle ignition frequency may refer to how frequently a vehicle is activated (e.g., how often the vehicle is ignited (e.g., if using a gas-powered vehicle), turned on, or otherwise started) and the frequency may be based on the number of activations within a predefined period (e.g., per day, per week, per month, per year, etc.). In some embodiments, the vehicle ignition frequency (e.g., vehicle ignition frequency 220) may be determined by the processor of the automotive embedded system via a controller area network (e.g., LPM-CAN 151). For example, the LPM-CAN 151 may receive signals for each activation of the vehicle to determine the vehicle ignition frequency. Also or alternatively, the LPM-CAN 151 may receive or determine the frequency of a signal indicating an ignition of the vehicle. The signal and/or the frequency of the signal may be provided by a vehicle system 172, such as the ignition module 250.

At block 304, the at least one processor (e.g., processor 210, CPU 104) may determine an occupancy rate of a dynamic memory of the automotive embedded system (e.g., occupancy rate 240 of memory 106 of the automotive embedded system 100). The occupancy rate may refer to a ratio or a proportion of cells of the dynamic memory storing data that is being used in active processes (e.g. of applications 110) to a total number of cells in the dynamic memory (e.g., cells 109 of memory 106). The cells storing data that are being used in the active processes may be referred to as actively used cells (e.g., actively used cells 232). The occupancy rate may refer to or may be based on the said ratio or proportion. The occupancy rate of the dynamic memory may thus relate to how occupied the automotive embedded system may be (e.g., based on ongoing applications and processes). For example, a greater number of processes associated with applications 110 running on the automotive embedded system 100 may involve the use of a greater number of cells 109 in the dynamic memory, resulting in a greater proportion of actively used cells 232 to total number of cells, and thus yielding a higher occupancy rate. In various embodiments, determining the occupancy rate of the dynamic memory includes determining whether the occupancy rate is above a predetermined threshold (referred to herein as a second threshold to distinguish from the first threshold relating to the vehicle ignition frequency).

At block 306, the at least one processor (e.g., processor 210, CPU 104) may determine, a power management mode for the automotive embedded system. The power management mode may be based on one or both of the vehicle ignition frequency and the occupancy rate. In some embodiments, the process may select a power management mode from one of a plurality of options. For example, the plurality of options may include a power management mode that optimizes for system image retention (e.g., context retention) during a boot up process. Furthermore, the plurality of options may include a power management mode that optimizes for boot KPIs. In some embodiments, a power management mode may also or alternatively optimize for reducing power consumption and/or extending battery life (e.g., when such power consumption mode is used regularly).

For example, in some embodiments, the power consumption modes may include a suspend to disk (S2D) power consumption mode and a deep sleep-quick boot (DS-QB) the DS-QB power management mode. As previously discussed, an S2D power management mode may achieve a relatively comprehensive state preservation of the automotive embedded system during a boot-up process, such as by preserving system images for high level operation systems (HLOS) and non-high level operation systems (HLOS) alike, as well as aspects or configurations of processors (e.g., Q6). Although S2D may not necessarily be optimized for boot KPIs, the use of S2D as a power management mode may benefit automotive embedded systems having the need to preserve a high occupancy rate due to a large load from ongoing applications (e.g., applications 110) on the dynamic memory.

Thus, if the vehicle ignition frequency is determined to be above the first threshold, and the occupancy rate of the dynamic memory is determined to above the second threshold (e.g., due to a greater use of cells in the dynamic memory due to greater use of applications), the processor may determine the power management mode for the automotive embedded system to be S2D, based on the vehicle ignition frequency and the occupancy rate. Furthermore, if the vehicle is turned on or turned off less frequently, there may be less concern for the battery consumption as compared to, for example, enhancing the user experience by improving retention of application processes. Thus, in some embodiments, if the at least one processor determines that the vehicle ignition frequency is below the first threshold, the at least one processor may determine that the power management mode for the automotive embedded system should be an S2D power management mode based on the vehicle ignition frequency.

In contrast, DS-QB may have better boot KPIs due to a more limited system image retention during a boot up process, which can ultimately lead to a longer battery life for the vehicle. As previously discussed, boot KPIs may include but are not limited to, a latency between vehicle ignition and the start or restoration of a process on the automotive embedded system, a latency between the vehicle ignition and an application launch or application restoration on the automotive embedded system, a latency between the vehicle ignition and the appearance of a graphical user interface on a dashboard of the vehicle, etc. The DS-QB may thus be selected for automotive embedded systems seeking to preserve battery life and/or reduce power consumption during a booting process or which may otherwise have lower vehicle usage due to applications. Thus, if the vehicle ignition frequency is determined to be above the first threshold, and the occupancy rate of the dynamic memory is below the second threshold (e.g., due to lesser use of applications prompting a lesser need to reinstate application processes upon starting a vehicle), the processor may determine the power management mode for the automotive embedded system to be DS-QB, based on the vehicle ignition frequency and the occupancy rate.

In some embodiments, the power management mode is determined via a machine learning model. For example, the machine learning model may be trained to output a power management mode based on inputs comprising a vehicle ignition frequency and an occupancy rate (e.g., based on training data of historical vehicle ignition frequencies and historical occupancy rates associated with actual and/or labeled outcomes of the power management mode).

At block 308, the at least one processor (e.g., processor 210, CPU 104) may configure the automotive embedded system (e.g., automotive embedded system 100) based on the power management mode (e.g., determined at block 306). For example, if the power management mode determined at block 306 is the DS-QB power management mode, the at least one processor may configure the automotive embedded system by determining application processes and system processes utilizing the dynamic memory. The at least one processor may then retain contexts (e.g., system images) for the application processes, but may reload the system processes during a start up of the automotive embedded system. In some embodiments, if the power management mode determined at block 306 is an S2D power management mode, the at least one processor may configure the automotive embedded system by also determining application processes and system processes utilizing the dynamic memory. However, for S2D power management mode, the processor may reload contexts for both the application processes and the system processes. By reloading application processes, the at least one processor may deliver the benefits of S2D power management mode of reinstating application processes prior to the boot-up process, thereby enhancing the user experience.

The operations described with reference to blocks 302, 304, 306, and 308 of FIG. 3 may be performed by any one or more of the processors of FIG. 1, including one or more of the CPU 104, the DSP 112, the GPU 126, or the NSP 124. For example, the CPU 104 may receive information concerning vehicle ignition frequency from the LPM-CAN 151 and receive information about the occupancy rate of the dynamic memory 106 based on the proportion of actively used cells 232 to the total cells 109 of the memory 106, and may rely on the configuration module 107 to determine and implement a power management mode for the automotive embedded system 100, as part of the operations of method 300. In another example, the processor performing the operations of blocks 302-308 may be dedicated logic circuitry for performing certain operations.

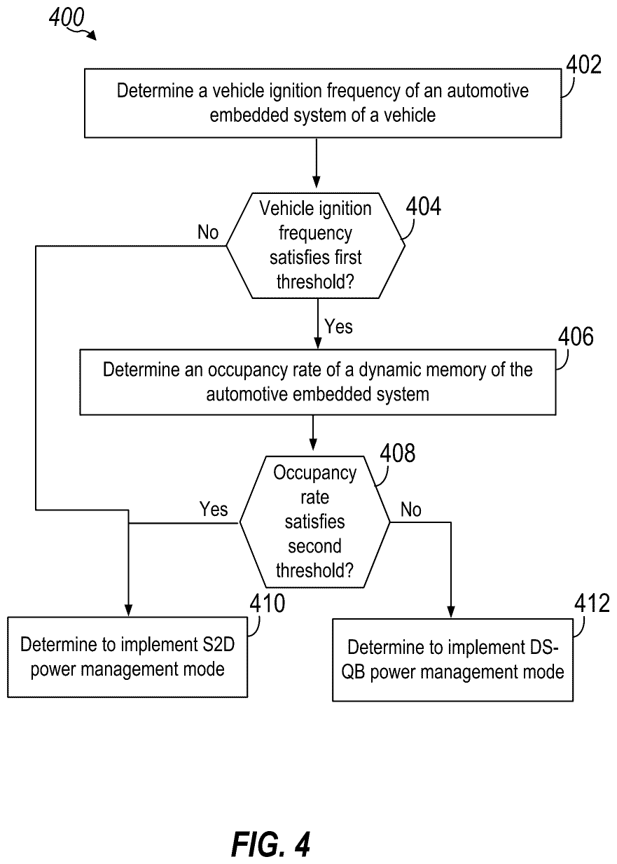

Aspects of the signal processing described in FIG. 3 are applied in example processes, such as the example method 400 of FIG. 4. FIG. 4 shows a process flow diagram of an example method 400 for dynamic power management of an automotive embedded system according to one or more aspects of this disclosure. One or more blocks of method 400 may be performed by at least one processor of an automotive embedded system of a vehicle, such as but not limited to processor 210 of automotive embedded system 100.

At block 402, the at least one processor (e.g., processor 210) may determine a vehicle ignition frequency of an automotive embedded system of a vehicle. In some embodiments, the vehicle ignition frequency (e.g., vehicle ignition frequency 220) may be determined by the processor of the automotive embedded system via a controller area network (such as but not limited to LPM-CAN 151) or other wired or wireless area network. For example, the LPM-CAN 151 may receive signals for each activation of the vehicle to determine the vehicle ignition frequency. Also or alternatively, the LPM-CAN 151 may receive or determine the frequency of a signal indicating an ignition of the vehicle. The signal and/or the frequency of the signal may be provided by a vehicle system 172, such as the ignition module 250.

At block 404, the at least one processor (e.g., processor 210) may determine whether the vehicle ignition frequency satisfies a first threshold. In some embodiments, the first threshold may be a predefined or preset number or range at which vehicle ignitions or activations at or above the number or range are deemed to be frequently activated (e.g., the vehicle is started or turned on frequently). In some embodiments, the first threshold may be redefined, adjusted, and/or updated. For example, it is contemplated that as vehicles evolve or as human needs for vehicles change, the bar to determine how frequent a vehicle being turned on is too frequent may change, which may involve adjusting the first threshold.

If the vehicle ignition frequency satisfies the first threshold, the at least one processor may, at block 406, determine an occupancy rate of a dynamic memory of the automotive embedded system. The occupancy rate may refer to a ratio or a proportion of cells of the dynamic memory storing data that is being used in active processes (e.g. of applications 110) to a total number of cells in the dynamic memory (e.g., cells 109 of memory 106). The cells storing data that are being used in the active processes may be referred to as actively used cells (e.g., actively used cells 232).

At block 408, the at least one processor (e.g., processor 210) may determine whether the occupancy rate satisfies a second threshold. The occupancy rate of the dynamic memory may thus relate to how occupied the automotive embedded system is based on ongoing application processes (e.g., of applications 110). Thus, in some embodiments, the second threshold may refer to a predetermined or preset proportion (e.g., percentage) or proportion range (e.g., percentage range), at which an automotive embedded system having an occupancy rate of its dynamic memory above the second threshold may be deemed to be in a high active use from application processes (e.g., of applications 110). In some embodiments, the second threshold may be redefined, adjusted, and/or updated. For example, it is contemplated that as other power management modes that also provide benefits of relatively greater state preservation (e.g., greater image and/or context retention are developed), and/or as automotive embedded systems evolve to run more and more applications, the bar to determine when an automotive embedded system is deemed to be in highly active use of applications may be higher, which may involve adjusting the second threshold to a greater threshold.

In some embodiments, the at least one processor may determine the vehicle ignition frequency and the occupancy rate non-sequentially. For example, in some embodiments, the at least one processor 210 of the automotive embedded system 100 may periodically receive signals from the ignition module 250 or other vehicle systems 172 via the LPM-CAN 151, to periodically monitor the vehicle ignition frequency 220 while periodically monitoring the occupancy rate 248 by periodically querying the dynamic memory 106 to determine the proportion of actively used cells 232 compared to the total cells 109. Thus, in some embodiments, block 406 may be performed even if the vehicle ignition frequency fails to satisfy the first threshold at block 404, and/or block 406 may be performed before block 404.

If the at least one processor determines that the vehicle ignition frequency does not satisfy the first threshold, the at least one processor may, at block 410, determine to implement the S2D power management mode on the automotive embedded system. Also or alternatively, if the at least one processor determines that the vehicle ignition frequency satisfies the first threshold and the occupancy rate satisfies the second threshold, the at least one processor may, at block 410, determine to implement the S2D power management mode on the automotive embedded system. The S2D power management mode may achieve a relatively greater state preservation of the automotive embedded system during a boot-up process compared to the DS-QB power management mode, even if the DS-QB may provide more favorable boot KPIs relative to the S2D power management mode. The use of S2D as a power management mode may benefit automotive embedded systems having the need to preserve a high occupancy rate due to a large load from ongoing applications (e.g., applications 110) on the dynamic memory. However, in some embodiments, a power management mode other than S2D that still provides the relatively greater state preservation may be implemented at block 410.

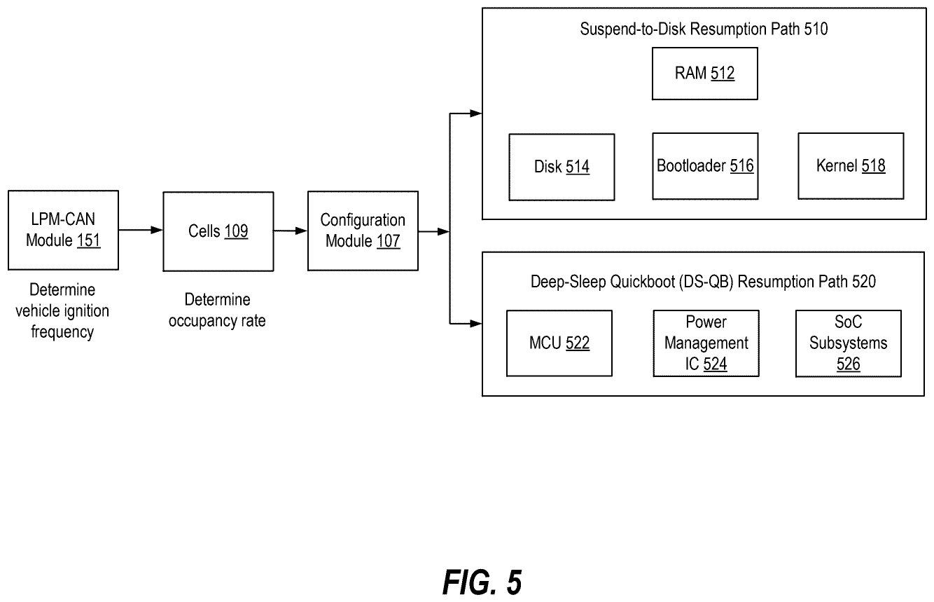

If the at least one processor determines that the vehicle ignition frequency satisfies the first threshold, but the occupancy rate fails to satisfy the second threshold, the at least one processor may, at block 412, determine to implement the DS-QB power management mode on the automotive embedded system. As previously discussed, the DS-QB power management mode may provide relatively better boot KPIs (e.g., reduced latency from vehicle activation to dashboard GUI display) compared to the S2D power management mode due to a more limited system image retention during a boot up process, which can ultimately lead to a longer battery life for the vehicle. However, in some embodiments, power management modes other than DS-QB, which still provides similar aforementioned tradeoffs as DS-QB may be implemented at block 412. FIG. 5 is a schematic diagram illustrating aspects of the automotive embedded system used in an example implementation of dynamic power management for the automotive embedded system according to one or more aspects of the disclosure. As shown in FIG. 5, the configuration module 107 intelligently determines and implements a power management mode that is appropriate for the automotive embedded system of the vehicle (e.g., automotive embedded system 100) based on the vehicle ignition frequency determined via the LPM-CAN module 151 and the occupancy rate of a dynamic memory determined based on the cells 109 of the dynamic memory 106 (e.g., the proportion of the cells 109 that are actively used cells 232). In the example shown in FIG. 5, information about the vehicle ignition frequency and the occupancy rate may enable the configuration module to intelligently determine and implement one of two power management modes by undertaking one of two respective resumption paths. The S2D resumption path 510 allows the configuration module 107 to configure the automotive embedded system to the S2D power management mode while the DS-QB resumption path 510 allows the configuration module 107 to configure the automotive embedded system to the DS-QB power management mode.

In some embodiments, the S2D resumption path 510 may involve saving the application processes and system processes of the automotive embedded system to a disk 514 or other secondary memory device (e.g., in memory 106). For example, at least one processor (e.g., via the configuration module 107) can implement a hibernation trigger mechanism (e.g., of the automotive embedded system) if the at least one processor has determined to implement the S2D power management mode. A sufficient memory may be allocated for a hibernation image, including actual memory content and a snapshot image, in order to provide the state preservation characteristic of the S2D power management mode. The processor (e.g., via configuration module 107) may then save the system state, including contents from the RAM 512 and memory-mapped I/O registers, to the hard disk 514 and swap space. In some aspects, a secure mechanism may be used for storing and verifying the integrity of the hibernation image. The S2D resumption path 510 may further utilize a bootloader 516 during a boot process to check for a valid hibernation image. The bootloader 516 may include a program or instruction responsible for booting the automotive embedded system. In some embodiments, the S2D resumption path 510 may further include a kernel stage, for reloading operating system processes via a kernel 518. The system state of the automotive embedded system 100 can then be restored from the swap, and drivers and devices can be restarted (e.g., using a restore callback).

In some embodiments, the DS-QB resumption path 520 may involve a microcontroller unit 522, a power management integrated circuit (IC) 524, and the various SoC subsystems 526 of the automotive embedded system 100. For example, after the at least one processor (e.g., via configuration module 107) has determined that the power management mode for the automotive embedded system should be the DS-QB power management mode (e.g., based on methods 300 and/or 400), the various SoC subsystems 526 may be notified (e.g., via signal communication) about the entry to the DS-QB resumption path. For example, a power state driver may be utilized by a kernel to send notifications and update global flags. The dynamic memory 106 may be entered (e.g., via the at least one processor or the MCU 522) into self-refresh mode and/or a partial array self refresh (PASR) mode to conserve power during a deep sleep to result from implementation of the DS-QB power management mode. The MCU 522 may thus cause the SoC subsystems 526 to enter into deep sleep. On wake-up from the deep sleep mode, the at least one processor 210, MCU 522, and/or configuration module 107 may leverage the power management IC to restore the SoC subsystems 526 and initiate a controlled exit from deep sleep. In some embodiments, a power-on sequence may be executed (e.g., by the at least one processor 210, MCU 522, and/or the configuration module 107 that distinguishes between deep sleep and cold boot to improve the wake-up process.

In one or more aspects, techniques for improving power management of automotive embedded systems in vehicles may include additional aspects, such as any single aspect or any combination of aspects described below or in connection with one or more other processes or devices described elsewhere herein. In a first aspect, a device with improved operations may include an apparatus comprising a memory storing processor-readable code; and one or more processors coupled to the memory, the one or more processors configured to execute the processor-readable code to cause the one or more processors to: determine a vehicle ignition frequency of an automotive embedded system of a vehicle; determine an occupancy rate of a dynamic memory of the automotive embedded system; determine, based on the vehicle ignition frequency and the occupancy rate, a power management mode for the automotive embedded system; and configure the automotive embedded system based on the power management mode.

Additionally, the apparatus may perform or operate according to one or more aspects as described below. In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of power management may include one or more operations described herein with reference to the apparatus.

In a second aspect, in combination with the first aspect, the one or more processors are configured to determine the vehicle ignition frequency by determining that the vehicle ignition frequency is above a first threshold; the one or more processors are configured to determine the occupancy rate of the dynamic memory by determining that the occupancy rate is above a second threshold; and the one or more processors are configured to determine the power management mode for the automotive embedded system by determining to implement a suspend to disk (S2D) power management mode based on the vehicle ignition frequency and the occupancy rate.

In a third aspect, in combination with one or more of the first aspect or the second aspect, the one or more processors are configured to determine the vehicle ignition frequency by determining that the vehicle ignition frequency is above a first threshold; the one or more processors are configured to determine the occupancy rate of the dynamic memory by determining that the occupancy rate is below a second threshold; and the one or more processors are configured to determine the power management mode for the automotive embedded system by determining to implement a deep sleep-quick boot (DS-QB) power management mode based on the vehicle ignition frequency and the occupancy rate.

In a fourth aspect, in combination with one or more of the first aspect through the third aspect, the one or more processors are configured to determine the vehicle ignition frequency by determining that the vehicle ignition frequency is below a first threshold, and the one or more processors are configured to determine the power management mode for the automotive embedded system by determining to execute a suspend to disk (S2D) operation based on the vehicle ignition frequency.

In a fifth aspect, in combination with one or more of the first aspect through the fourth aspect, the one or more processors are configured to determine the vehicle ignition frequency by: determining a frequency of a signal received by a low power mode controller area network (LPM-CAN) of the automotive embedded system indicating an ignition of the vehicle.

In a sixth aspect, in combination with one or more of the first aspect through the fifth aspect, the one or more processors are configured to determine the occupancy rate of the dynamic memory by: determining a ratio of cells of the dynamic memory storing data used in active processes to a total number of cells in the dynamic memory, wherein the occupancy rate is based on the ratio.

In a seventh aspect, in combination with one or more of the first aspect through the sixth aspect, the power management mode is a deep sleep-quick boot (DS-QB) power management mode; and the one or more processors are configured to configure the automotive embedded system by: determining application processes and system processes utilizing the dynamic memory; retaining contexts for the application processes; and reloading the system processes during a start up of the automotive embedded system.

In an eighth aspect, in combination with one or more of the first aspect through the seventh aspect, the power management mode is a suspend to disk (S2D) power management mode; and the one or more processors are configured to configure the automotive embedded system based on the power management mode by: determining application processes and system processes utilizing the dynamic memory; and retaining contexts for the application processes and the system processes.

In a ninth aspect, in combination with one or more of the first aspect through the eighth aspect, the one or more processors are configured to determine the power management mode via a machine learning model; and the machine learning model is trained to output a power management mode based on inputs comprising a vehicle ignition frequency and an occupancy rate.

In a tenth aspect, automotive embedded system for improvement in power management is disclosed. The automotive embedded system includes: a low power mode controller area network (LPM-CAN) configured to receive a signal indicating an ignition of a vehicle; a memory; and at least one processor coupled to the memory and the LPM-CAN. The at least one processor is configured to execute processor-readable code to cause the at least one processor to perform operations comprising: determining, based on input from the LPM-CAN, a vehicle ignition frequency of an automotive embedded system of a vehicle; determining an occupancy rate of the memory; and determining, based on the vehicle ignition frequency and the occupancy rate, a power management mode for the automotive embedded system comprising one of a suspend to disk (S2D) operation or a deep sleep-quick boot (DS-QB) operation; and configuring the automotive embedded system based on the power management mode.

In an eleventh aspect, in combination with tenth aspect, the at least one processor is configured to determine the vehicle ignition frequency by determining whether the vehicle ignition frequency satisfies a first threshold; wherein the at least one processor is configured to determine the occupancy rate of the memory by determining whether the occupancy rate satisfies a second threshold; wherein the at least one processor is configured to determine the power management mode for the automotive embedded system by determining to execute a suspend to disk (S2D) operation when: the vehicle ignition frequency satisfies the first threshold and the occupancy rate satisfies the second threshold, or the vehicle ignition frequency is not above the first threshold; and wherein the at least one processor is configured to determine the power management mode for the automotive embedded system by determining to execute a deep sleep-quick boot (DS-QB) operation when the vehicle ignition frequency satisfies the first threshold and the occupancy rate fails to satisfy the second threshold.

In a twelfth aspect, a method for dynamic power management of automotive embedded systems in vehicles is disclosed. The method includes: determining, by a processor, a vehicle ignition frequency of an automotive embedded system of a vehicle; determining, by the processor, an occupancy rate of a dynamic memory of the automotive embedded system; determining, by the processor, based on the vehicle ignition frequency and the occupancy rate, a power management mode for the automotive embedded system; and configuring, by the processor, the automotive embedded system based on the power management mode.

In a thirteenth aspect, in combination with the twelfth aspect, determining the vehicle ignition frequency includes determining that the vehicle ignition frequency is above a first threshold; determining the occupancy rate of the dynamic memory includes determining that the occupancy rate is above a second threshold; and determining the power management mode for the automotive embedded system includes determining to implement a suspend to disk (S2D) power management mode based on the vehicle ignition frequency and the occupancy rate.

In a fourteenth aspect, in combination with one or more of the twelfth aspect through the thirteenth aspect, determining the vehicle ignition frequency includes determining that the vehicle ignition frequency is above a first threshold; determining the occupancy rate of the dynamic memory includes determining that the occupancy rate is below a second threshold; and determining the power management mode for the automotive embedded system includes determining to implement a deep sleep-quick boot (DS-QB) power management mode based on the vehicle ignition frequency and the occupancy rate.

In a fifteenth aspect, in combination with one or more of the twelfth aspect through the fourteenth aspect, determining the vehicle ignition frequency comprises determining that the vehicle ignition frequency is below a first threshold. Determining the power management mode for the automotive embedded system includes determining to implement a suspend to disk (S2D) power management mode based on the vehicle ignition frequency.

In a sixteenth aspect, in combination with one or more of the twelfth aspect through the fifteenth aspect, determining the vehicle ignition frequency comprises: determining, by the processor, a frequency of a signal received by a low power mode controller area network (LPM-CAN) of the automotive embedded system indicating an ignition of the vehicle.

In a seventeenth aspect, in combination with one or more of the twelfth aspect through the sixteenth aspect, determining the occupancy rate of the dynamic memory includes: determining a ratio of cells of the dynamic memory storing data used in active processes to a total number of cells in the dynamic memory. The occupancy rate is based on the ratio.

In an eighteenth aspect, in combination with one or more of the twelfth aspect through the seventeenth aspect, the power management mode is a deep sleep-quick boot (DS-QB) power management mode. Furthermore, configuring the automotive embedded system includes: determining, by the processor, application processes and system processes utilizing the dynamic memory; retaining, by the processor, contexts for the application processes; and reloading, by the processor, the system processes during a start up of the automotive embedded system.

In a nineteenth aspect, in combination with one or more of the twelfth aspect through the eighteenth aspect, the power management mode is a suspend to disk (S2D) power management mode. Furthermore configuring the automotive embedded system includes: determining, by the processor, application processes and system processes utilizing the dynamic memory; and retaining, by the processor, contexts for the application processes and the system processes.

In a twentieth aspect, in combination with one or more of the twelfth aspect through the nineteenth aspect, the power management mode is determined via a machine learning model. The machine learning model is trained to output a power management mode based on inputs comprising a vehicle ignition frequency and an occupancy rate.

In the figures, a single block may be described as performing a function or functions. The function or functions performed by that block may be performed in a single component or across multiple components, and/or may be performed using hardware, software, or a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory, and the like.

Unless specifically stated otherwise as apparent from the following discussions, it is appreciated that throughout the present application, discussions using terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” “generating,” or the like, refer to the actions and processes of a computer system, or similar electronic computing device, that manipulates and transforms data represented as physical (electronic) quantities within the computer system's registers and memories into other data similarly represented as physical quantities within the computer system's registers, memories, or other such information storage, transmission, or display devices. The use of different terms referring to actions or processes of a computer system does not necessarily indicate different operations. For example, “determining” data may refer to “generating” data. As another example, “determining” data may refer to “retrieving” data.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the description and examples herein use the term “device” to describe various aspects of the disclosure, the term “device” is not limited to a specific configuration, type, or number of objects. As used herein, an apparatus may include a device or a portion of the device for performing the described operations.

Certain components in a device or apparatus described as “means for accessing,” “means for receiving,” “means for sending,” “means for using,” “means for selecting,” “means for determining,” “means for normalizing,” “means for multiplying,” or other similarly-named terms referring to one or more operations on data, such as image data, may refer to processing circuitry (e.g., application specific integrated circuits (ASICs), digital signal processors (DSP), graphics processing unit (GPU), central processing unit (CPU), computer vision processor (CVP), or neural signal processor (NSP)) configured to perform the recited function through hardware, software, or a combination of hardware configured by software.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to the Figures referenced above include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill in the art that one or more blocks (or operations) described with reference to FIG. 3 may be combined with one or more blocks (or operations) described with reference to another of the figures. For example, one or more blocks (or operations) of FIG. 3 may be combined with one or more blocks (or operations) of FIG. 1 or FIG. 2. As another example, one or more blocks associated with FIGS. 4 and 5 may be combined with one or more blocks (or operations) associated with FIGS. 1-3.

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits, and processes described above. Whether such functionality is implemented in hardware or software depends upon the particular application and design constraints imposed on the overall system.

In one or more aspects, the operations described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, which is one or more modules of computer program instructions, encoded on a computer storage media for execution by, or to control the operation of, data processing apparatus.

The operations of a method or algorithm disclosed herein may be implemented in a processor-executable software module which may reside on a computer-readable medium and commercially made available as a computer program product as software. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc wherein disks usually reproduce data magnetically and discs reproduce data optically with lasers. Combinations of the above should also be included within the scope of computer-readable media.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein but are to be accorded the widest scope consistent with this disclosure, the principles and the novel features disclosed herein.

Additionally, a person having ordinary skill in the art will readily appreciate, opposing terms such as “upper” and “lower,” or “front” and back,” or “top” and “bottom,” or “forward” and “backward,” or “left” and “right” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown, or in sequential order, or that all illustrated operations be performed to achieve desirable results. Further, the drawings may schematically depict one or more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof.

The term “substantially” is defined as largely, but not necessarily wholly, what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method, comprising:
determining, by a processor, a vehicle ignition frequency of an automotive embedded system of a vehicle;
determining, by the processor, an occupancy rate of a dynamic memory of the automotive embedded system;
determining, by the processor, based on the vehicle ignition frequency and the occupancy rate, a power management mode for the automotive embedded system; and
configuring, by the processor, the automotive embedded system based on the power management mode.

2. The method of claim 1,
wherein determining the vehicle ignition frequency comprises determining that the vehicle ignition frequency is above a first threshold,
wherein determining the occupancy rate of the dynamic memory comprises determining that the occupancy rate is above a second threshold,
wherein determining the power management mode for the automotive embedded system comprises determining to implement a suspend to disk (S2D) power management mode based on the vehicle ignition frequency and the occupancy rate.

3. The method of claim 1,
wherein determining the vehicle ignition frequency comprises determining that the vehicle ignition frequency is above a first threshold,
wherein determining the occupancy rate of the dynamic memory comprises determining that the occupancy rate is below a second threshold,
wherein determining the power management mode for the automotive embedded system comprises determining to implement a deep sleep-quick boot (DS-QB) power management mode based on the vehicle ignition frequency and the occupancy rate.

4. The method of claim 1,
wherein determining the vehicle ignition frequency comprises determining that the vehicle ignition frequency is below a first threshold, and
wherein determining the power management mode for the automotive embedded system comprises determining to implement a suspend to disk (S2D) power management mode based on the vehicle ignition frequency.

5. The method of claim 1, wherein determining the vehicle ignition frequency comprises:
determining, by the processor, a frequency of a signal received by a low power mode controller area network (LPM-CAN) of the automotive embedded system indicating an ignition of the vehicle.

6. The method of claim 1, wherein determining the occupancy rate of the dynamic memory comprises:
determining a ratio of cells of the dynamic memory storing data used in active processes to a total number of cells in the dynamic memory, wherein the occupancy rate is based on the ratio.

7. The method of claim 1, wherein the power management mode is a deep sleep-quick boot (DS-QB) power management mode, wherein configuring the automotive embedded system comprises:
determining, by the processor, application processes and system processes utilizing the dynamic memory;
retaining, by the processor, contexts for the application processes; and
reloading, by the processor, the system processes during a start up of the automotive embedded system.

8. The method of claim 1, wherein the power management mode is a suspend to disk (S2D) power management mode, wherein configuring the automotive embedded system comprises:
determining, by the processor, application processes and system processes utilizing the dynamic memory; and
retaining, by the processor, contexts for the application processes and the system processes.

9. The method of claim 1, wherein the power management mode is determined via a machine learning model, wherein the machine learning model is trained to output a power management mode based on inputs comprising a vehicle ignition frequency and an occupancy rate.

10. An apparatus, comprising:
a memory storing processor-readable code; and
one or more processors coupled to the memory, the one or more processors configured to execute the processor-readable code to cause the one or more processors to:
determine a vehicle ignition frequency of an automotive embedded system of a vehicle;
determine an occupancy rate of a dynamic memory of the automotive embedded system; and
determine, based on the vehicle ignition frequency and the occupancy rate, a power management mode for the automotive embedded system; and
configure the automotive embedded system based on the power management mode.

11. The apparatus of claim 10,
wherein the one or more processors are configured to determine the vehicle ignition frequency by determining that the vehicle ignition frequency is above a first threshold,
wherein the one or more processors are configured to determine the occupancy rate of the dynamic memory by determining that the occupancy rate is above a second threshold,
wherein the one or more processors are configured to determine the power management mode for the automotive embedded system by determining to implement a suspend to disk (S2D) power management mode based on the vehicle ignition frequency and the occupancy rate.

12. The apparatus of claim 10,
wherein the one or more processors are configured to determine the vehicle ignition frequency by determining that the vehicle ignition frequency is above a first threshold,
wherein the one or more processors are configured to determine the occupancy rate of the dynamic memory by determining that the occupancy rate is below a second threshold,
wherein the one or more processors are configured to determine the power management mode for the automotive embedded system by determining to implement a deep sleep-quick boot (DS-QB) power management mode based on the vehicle ignition frequency and the occupancy rate.

13. The apparatus of claim 10,
wherein the one or more processors are configured to determine the vehicle ignition frequency by determining that the vehicle ignition frequency is below a first threshold, and
wherein the one or more processors are configured to determine the power management mode for the automotive embedded system by determining to execute a suspend to disk (S2D) operation based on the vehicle ignition frequency.

14. The apparatus of claim 10, wherein the one or more processors are configured to determine the vehicle ignition frequency by:
determining a frequency of a signal received by a low power mode controller area network (LPM-CAN) of the automotive embedded system indicating an ignition of the vehicle.

15. The apparatus of claim 10, wherein the one or more processors are configured to determine the occupancy rate of the dynamic memory by:
determining a ratio of cells of the dynamic memory storing data used in active processes to a total number of cells in the dynamic memory, wherein the occupancy rate is based on the ratio.

16. The apparatus of claim 10, wherein the power management mode is a deep sleep-quick boot (DS-QB) power management mode, wherein the one or more processors are configured to configure the automotive embedded system by:
determining application processes and system processes utilizing the dynamic memory;
retaining contexts for the application processes; and
reloading the system processes during a start up of the automotive embedded system.

17. The apparatus of claim 10, wherein the power management mode is a suspend to disk (S2D) power management mode, wherein the one or more processors are configured to configure the automotive embedded system based on the power management mode by:
determining application processes and system processes utilizing the dynamic memory; and
retaining contexts for the application processes and the system processes.

18. The apparatus of claim 10, wherein the one or more processors are configured to determine the power management mode via a machine learning model, wherein the machine learning model is trained to output a power management mode based on inputs comprising a vehicle ignition frequency and an occupancy rate.

19. An automotive embedded system, comprising:
a low power mode controller area network (LPM-CAN) configured to receive a signal indicating an ignition of a vehicle;
a memory; and
at least one processor coupled to the memory and the LPM-CAN, wherein the at least one processor is configured to execute processor-readable code to cause the at least one processor to perform operations comprising:
determining, based on input from the LPM-CAN, a vehicle ignition frequency of an automotive embedded system of a vehicle;
determining an occupancy rate of the memory; and
determining, based on the vehicle ignition frequency and the occupancy rate, a power management mode for the automotive embedded system comprising one of a suspend to disk (S2D) operation or a deep sleep-quick boot (DS-QB) operation; and
configuring the automotive embedded system based on the power management mode.

20. The automotive embedded system of claim 19,
wherein the at least one processor is configured to determine the vehicle ignition frequency by determining whether the vehicle ignition frequency satisfies a first threshold;
wherein the at least one processor is configured to determine the occupancy rate of the memory by determining whether the occupancy rate satisfies a second threshold;
wherein the at least one processor is configured to determine the power management mode for the automotive embedded system by determining to execute a suspend to disk (S2D) operation when:
the vehicle ignition frequency satisfies the first threshold and the occupancy rate satisfies the second threshold, or
the vehicle ignition frequency is not above the first threshold; and
wherein the at least one processor is configured to determine the power management mode for the automotive embedded system by determining to execute a deep sleep-quick boot (DS-QB) operation when the vehicle ignition frequency satisfies the first threshold and the occupancy rate fails to satisfy the second threshold.
